(19) United States
(12) Patent Application Publication
(10) Pub. No.: US 2021/0176528 A1
(43) Pub. Date: Jun. 10, 2021

(54) METHOD AND SYSTEM TO PREVIEW CONTENT WHILE PLAYING SELECTED CONTENT

(71) Applicant: ARRIS Enterprises LLC, Suwanee, GA (US)

(72) Inventors: Kaliraj KALAICHELVAN, San Diego, CA (US); Ernest G. SCHMITT, Maple Glen, PA (US); William P. FRANKS, San Diego, CA (US)

(73) Assignee: ARRIS Enterprises LLC, Suwanee, GA (US)

(21) Appl. No.: 17/116,333

(22) Filed: Dec. 9, 2020

Related U.S. Application Data
(60) Provisional application No. 62/946,409, filed on Dec. 10, 2019.
(60) Provisional application No. 63/046,501, filed on Jun. 30, 2020.

(51) Int. Cl. H04N 21/4402; H04N 21/442; H04N 21/431

(52) U.S. Cl. CPC H04N 21/440263; H04N 21/431; H04N 21/44204

(57) ABSTRACT

A method, a customer-premises equipment device, and a non-transitory computer readable medium are disclosed for previewing content while playing selected content. The method includes delivering, from a set-top box, a first data stream of a first selected media content to a media play device, the first data stream including an audio stream and a video stream; receiving, on the set-top box, a request for a preview of a second selected media content; and delivering, from the set-top box, a second data stream of the preview of the second selected media content to the media play device, the second data stream including at least a video stream.

### CROSS-REFERENCE TO RELATED APPLICATIONS

This application claims the benefit of U.S. Provisional Patent Application Ser. No. 62/946,409, filed on Dec. 10, 2019, and U.S. Provisional Patent Application Ser. No. 63/046,501, filed on Jun. 30, 2020, the entire content of both of which is hereby incorporated herein by reference.

### TECHNICAL FIELD

The present disclosure generally relates to a method and apparatus to preview content while playing selected content.

### BACKGROUND

Cable service providers, which are also referred to as Multiple System Operators (“MSO”), or any communication or content distribution business that operates through a cable network, renders its services to its subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard.

To provide television and data services, a MSO typically uses a Cable Modem Termination System (“CMTS”) for the data services and a quadrature amplitude modulation (“QAM”) multiplexer for downstream broadcast television, narrow cast and video-on-demand (VoD) traffic signals. These devices may be located at one or more hubs, which are typically connected to a head end via a network according to a networking protocol, such as Ethernet or SONET. A residential cable customer is typically connected to the CMTS and hub via a cable modem and a wireless router that may be combined in a single box which is called a gateway. In order to view video content that is transmitted through the cable modem or gateway, residential customers connect their televisions to a set-top box (STB). Since set-top boxes have recently gained additional features and functionality, they are often referred to as a smart media device (“SMD”) and can be considered as the network interface controller for their peripheral devices.

The set-top box can be used by the subscriber to access a variety of multimedia services, including but not limited to live or linear television, digital video recorder (DVR) content, video-on-demand (VoD) content, over-the-top (OTT) content, and others. For example, set-top boxes usually play user selected content, for example, either live or with a digital video recorder (DVR). It would be desirable to be able to preview content before selection while playing an already selected content or when playback is started the first time. The current style of implementation uses thumbnail arts or thumbnail images to indicate an idea or subject matter of the content, which can be too restrictive to understand the nature of the content and its current state of playing.

### SUMMARY

In accordance with exemplary embodiments, a method and an apparatus are disclosed that allows content to be previewed while playing selected content, and which integrates content over IP streaming and/or disk for “preview play” during a user selection process, and wherein the “preview play” can include age appropriate trailers and/or live streaming.

In accordance with an aspect, a method is disclosed for previewing content while playing selected content, the method comprising: delivering, from a set-top box, a first data stream of a first selected media content to a media play device, the first data stream including an audio stream and a video stream; receiving, on the set-top box, a request for a preview of a second selected media content; and delivering, from the set-top box, a second data stream of the preview of the second selected media content to the media play device, the second data stream including at least a video stream.

In accordance with another aspect, a customer-premises equipment device is comprising: a processor configured to: deliver a first data stream of a first selected media content to a media play device, the first data stream including an audio stream and a video stream; receive a request for a preview of a second selected media content; and deliver a second data stream of the preview of the second selected media content to the media play device, the second data stream including at least a video stream.

In accordance with an aspect, a non-transitory computer readable medium is disclosed having instructions operable to cause one or more processors to perform operations comprising: delivering, from a set-top box, a first data stream of a first selected media content to a media play device, the first data stream including an audio stream and a video stream; receiving, on the set-top box, a request for a preview of a second selected media content; and delivering, from the set-top box, a second data stream of the preview of the second selected media content to the media play device, the second data stream including at least a video stream.

### BRIEF DESCRIPTION OF THE DRAWINGS

FIG. 1 is an illustration of an exemplary network environment for a method and apparatus to preview content while playing selected content.

FIG. 2 is an exemplary hardware architecture for an embodiment of a communication device.

FIG. 3 illustrates a representative system for previewing content while playing selected content.

FIG. 4 illustrates a media play device previewing content while playing selected content in accordance with an embodiment.

FIG. 5 is a flow chart of a method for previewing content while playing selected content in accordance with an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

System for Synchronized Viewing of Content over Multiple Devices

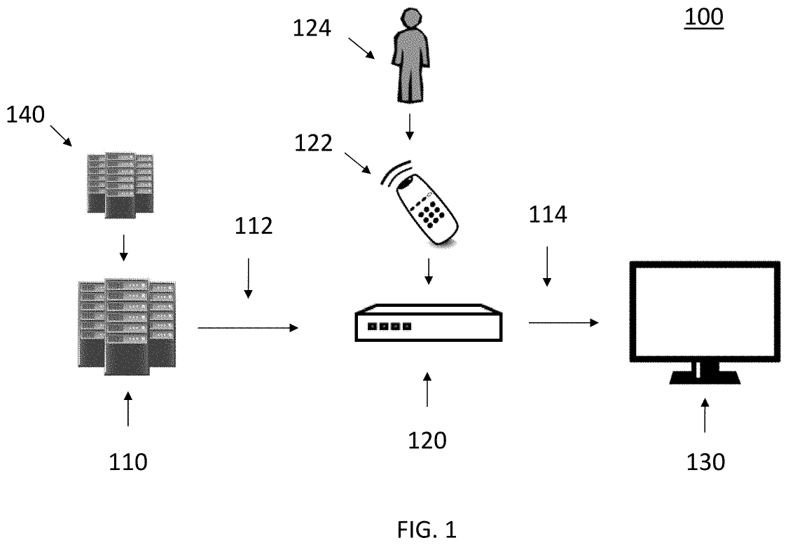

FIG. 1 is a block diagram illustrating an example network environment 100 to preview content while playing selected content. In embodiments, a cable provider (or MSO) server 110 can provide, for example, media content, for example, video and/or data services to a set-top box 120, for example, a customer premise equipment (CPE) device. The set-top box 120 may communicate with one or more media play devices 130 over a local network 114 (for example, a local area network (LAN), a wireless local area network (WLAN), a personal area network (PAN), etc.) and/or wired, for example, a television. The set-top box 120 may communicate with an upstream wide area network (WAN) 112 to the cable provider server 110. In accordance with an embodiment, the cable provider server 110 can provide high-bandwidth data transfer, for example, media content, cable television and broadband internet access.

In accordance with an exemplary embodiment, the media device 130 may be any type of computing device configured to connect via a wireless network, for example, wireless network utilizing an IEEE 802.11 specification, including a smart phone, a smart TV, a computer, a mobile device, a tablet, or any other device operable to communicate wirelessly with the set-top box 120. In accordance with an alternative embodiment, the media device 130 can be a television, for example, that is directly connected to the set-top box 120.

In accordance with an exemplary embodiment, the set-top box 120 may communicate with the cable provider server 110 over a wired or a wireless connection. A wireless connection between the cable provider server 110 and the set-top box 120 may be established through a protected setup sequence (for example, Wi-Fi protected setup (WPS)). The protected setup sequence may include the steps of scanning multiple wireless channels for an available access point, exchanging one or more messages between a station and access point, exchanging key messages (for example, pre-shared key (PSK)) between the station and access point, and installing a key (for example, PSK) at the station.

As set forth, the set-top box 120, for example, customer premise equipment (CPE) device, typically provides access a variety of multimedia services, including but not limited to live or linear television, digital video recorder (DVR) content, video-on-demand (VoD) content, over-the-top (OTT) content, and others. Alternatively, the customer premise equipment 120 can receive Internet Protocol-based (IP-based) streaming content from through the upstream wide area network (WAN) 112 and cable provider server 110. In embodiments, various data, multimedia, and/or voice services may be delivered to the set-top box 120 including but not limited to, live or broadcast television, video-on-demand (VoD) content, pay-per view content, recorded content (e.g., DVR content), audio-only content, streaming content, and others. The set-top box 120 may process and output content to one or more media play device 130 such as a television, mobile device, tablet, computer, and any other device operable to receive video, voice, and/or data services.

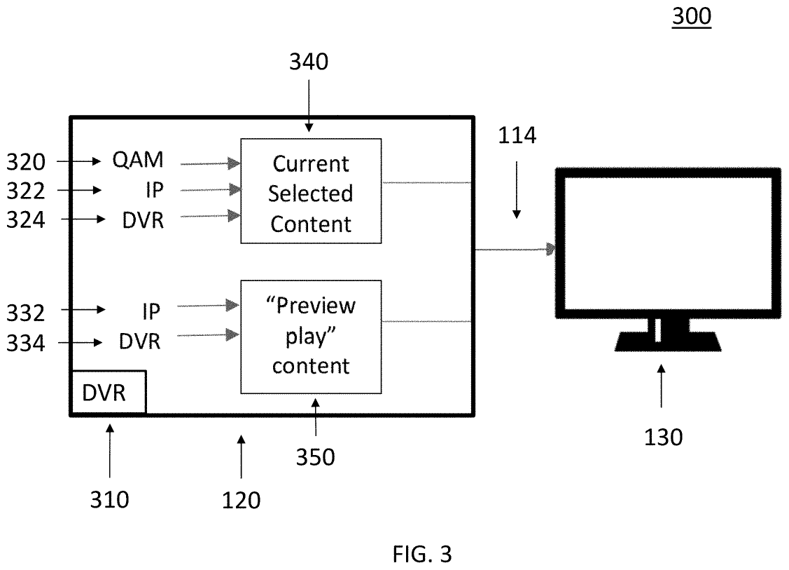

In accordance with an embodiment, a user 124 playing selected content either live or recorded, for example, may wish to preview additional content prior to switching from the currently selected content. In accordance with an embodiment, the user 124 can request a preview of additional content by using a voice command feature of an input device 122 or pressing a key or keys on the input device 110. Upon this action, the set-top box 120 can parse the signal from the input device 110, 122, determine the identity of the content from the information in the input signal as well as which resource to which the set-top box has available (e.g., from its memory or a memory device attached to it, the Internet via URL look-up, or from another source to which the set-top box 120 is in electronic communication, retrieve the preview of the additional content from the source of the content. The source of the content may be, for example, a cable provider server 110, an IP-based streaming service 140, for example, via the cable provider server 110, or a digital video recorder 310 (FIG. 3), for example, within the set-top box 120 as disclosed herein. In accordance with an embodiment, the preview of the additional content can be, for example, trailers, small clips, short scenes or hot spots located with the video, curated content, thumbnails and/or captured content of movies and/or pre-recorded content, and/or live content. In addition, the trailers, small clips, short scenes or hot spots, curated content, thumbnails and/or captured content of movies and/or pre-recorded content, and/or live content may be age appropriate.

In accordance with an aspect, the input device 122 may be a remote control, mobile computing device (e.g., a tablet computer, cellular phone, smart phone, etc.), camera, microphone, or other suitable input device that may be interfaced with the equipment device 102 to provide user accessibility and input of user instructions.

### Computer System Architecture

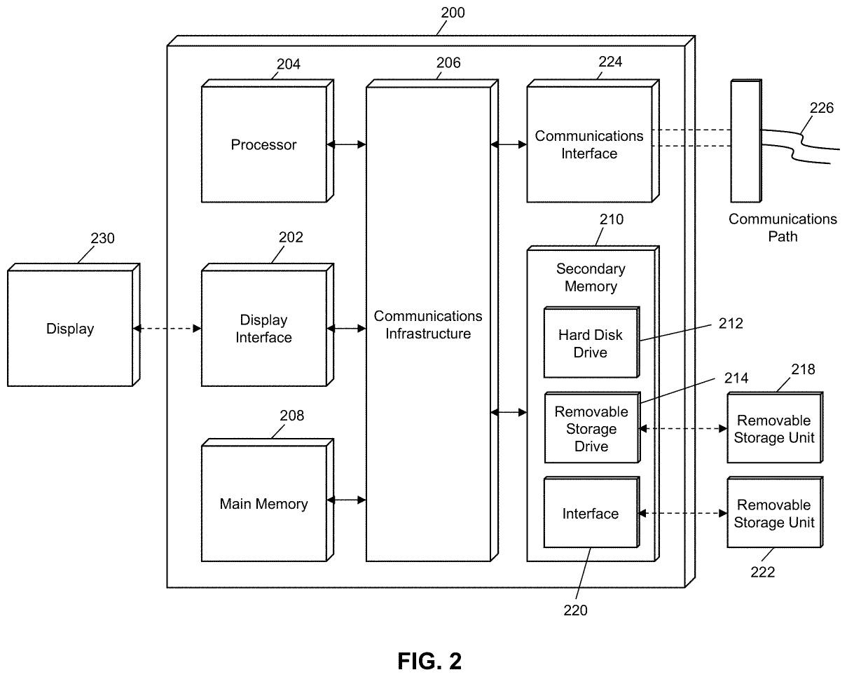

FIG. 2 illustrates a representative computer system 200 in which embodiments of the present disclosure, or portions thereof, may be implemented as computer-readable code executed on hardware. For example, the cable provider server 110, the set-top box 120, and the media play device 130 of FIGS. 1, 3, and 4 may be implemented in whole or in part by a computer system 200 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 218, a removable storage unit 222, and a hard disk installed in hard disk drive 212.

Various embodiments of the present disclosure are described in terms of this representative computer system 200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 204 may be processor device specifically configured to perform the functions discussed herein. The processor device 204 may be connected to a communications infrastructure 206, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 200 may also include a main memory 208 (e.g., random access memory, read-only memory, etc.), and may also include a secondary memory 210. The secondary memory 210 may include the hard disk drive 212 and a removable storage drive 214, such as a floppy disk drive, a magnetic tape drive, an optical disk drive, a flash memory, etc.

The removable storage drive 214 may read from and/or write to the removable storage unit 218 in a well-known manner. The removable storage unit 218 may include a removable storage media that may be read by and written to by the removable storage drive 214. For example, if the removable storage drive 214 is a floppy disk drive or universal serial bus port, the removable storage unit 218 may be a floppy disk or portable flash drive, respectively. In one embodiment, the removable storage unit 218 may be non-transitory computer readable recording media.

In some embodiments, the secondary memory 210 may include alternative means for allowing computer programs or other instructions to be loaded into the computer system 200, for example, the removable storage unit 222 and an interface 220. Examples of such means may include a program cartridge and cartridge interface (e.g., as found in video game systems), a removable memory chip (e.g., EEPROM, PROM, etc.) and associated socket, and other removable storage units 222 and interfaces 220 as will be apparent to persons having skill in the relevant art.

Data stored in the computer system 200 (e.g., in the main memory 208 and/or the secondary memory 210) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 200 may also include a communications interface 224. The communications interface 224 may be configured to allow software and data to be transferred between the computer system 200 and external devices. Exemplary communications interfaces 224 may include a modem, a network interface (e.g., an Ethernet card), a communications port, a PCMCIA slot and card, etc. Software and data transferred via the communications interface 224 may be in the form of signals, which may be electronic, electromagnetic, optical, or other signals as will be apparent to persons having skill in the relevant art. The signals may travel via a communications path 226, which may be configured to carry the signals and may be implemented using wire, cable, fiber optics, a phone line, a cellular phone link, a radio frequency link, etc.

The computer system 200 may further include a display interface 202. The display interface 202 may be configured to allow data to be transferred between the computer system 200 and external display 230. Exemplary display interfaces 202 may include high-definition multimedia interface (HDMI), digital visual interface (DVI), video graphics array (VGA), etc. The display 230 may be any suitable type of display for displaying data transmitted via the display interface 202 of the computer system 200, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 208 and secondary memory 210, which may be memory semiconductors (e.g., DRAMs, etc.). These computer program products may be means for providing software to the computer system 200. Computer programs (e.g., computer control logic) may be stored in the main memory 308 and/or the secondary memory 210. Computer programs may also be received via the communications interface 224. Such computer programs, when executed, may enable computer system 200 to implement the present methods as discussed herein. In particular, the computer programs, when executed, may enable processor device 204 to implement the methods illustrated by FIGS. 1, 3, and 4 as discussed herein. Accordingly, such computer programs may represent controllers of the computer system 200. Where the present disclosure is implemented using software executed on hardware, the software may be stored in a computer program product and loaded into the computer system 200 using the removable storage drive 214, interface 220, and hard disk drive 212, or communications interface 224.

The processor device 204 may comprise one or more modules or engines configured to perform the functions of the computer system 200. Each of the modules or engines may be implemented using hardware and, in some instances, may also utilize software executed on hardware, such as corresponding to program code and/or programs stored in the main memory 208 or secondary memory 210. In such instances, program code may be compiled by the processor device 204 (e.g., by a compiling module or engine) prior to execution by the hardware of the computer system 200. For example, the program code may be source code written in a programming language that is translated into a lower level language, such as assembly language or machine code, for execution by the processor device 204 and/or any additional hardware components of the computer system 200. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 200 to perform the functions disclosed herein. It will be apparent to persons having skill in the relevant art that such processes result in the computer system 200 being a specially configured computer system 200 uniquely programmed to perform the functions discussed above.

System for Previewing Content while Playing Selected Content

FIG. 3 illustrates a representative system 300 for previewing content while playing selected content in accordance with an exemplary embodiment. In accordance with an exemplary embodiment, as shown in FIG. 3, the currently selected content 340 can be delivered to a set-top box 120, for example, to a digital set-top box, in a quadrature amplitude modulation (QAM) 320 format, as an Internet Protocol (IP) content stream 322, and/or in a digital video recorder (DVR) format 324. For example, a quadrature amplitude modulation (“QAM”) multiplexer associated with the cable provider server 110 can deliver downstream broadcast television and/or the IP-based content stream to the set-top box 120 that is then displayed on the media play device 130. In accordance with an embodiment, the currently selected content 340 can be video content available for playback, for example, from a digital video recorder (DVR) 310 within the set-top box 120, and wherein the video content has been recorded, transcoded, and stored in one or more video formats.

In accordance with an exemplary embodiment, the digital video recorder (DVR) 310 can be configured to deliver the digital video (DV) content in one more digital video recorder (DVR) formats 324, 334, that can consist of a different video resolution and bitrate, to enable adaptive bitrate streaming. In accordance with an embodiment, the multiplicity of different stream formats and bitrates can enable the currently selected content 340 ad the preview play content 350 to be sourced to media play devices 130 with different capabilities, such as high definition televisions of wide ranging sizes, personal computers, tablet computers, smart phones, and other client devices. In addition, the different bitrates support adaptive streaming, whereby the receiving media play device 130 has the ability to measure network congestion and request a lower or higher bitrate stream from the source which may eliminate visual impairments caused by network congestion (e.g. macro-blocking due to dropped packets, frozen frames) at the expense of higher resolution video.

In accordance with an embodiment, the currently selected content 340 can be in IP-based content streaming format 322, for example, HTTP Live Streaming (HLS) or Dynamic Adaptive Streaming over HTTP (DASH), and which may be used to deliver the adaptive bitrate content to end users. In accordance with the IP-based content streaming format 322, the related video delivery protocol having adaptive bitrate streaming that can detect, for example, a bandwidth and central processing unit (CPU) capacity in real time of the set-top box 120 and/or the media play device 130 and can adjust the quality of the media stream being delivered over the local network 114 accordingly.

In accordance with an embodiment, content received in the IP-based streaming content format 332 or in the digital video recorder (DVR) format 334 can also be used as “preview play” content 350. For example, as set forth, the IP related video content streaming 332 can include but not limited to HTTP Live streaming (HLS) and Dynamic Adaptive Streaming over HTTP (DASH). In accordance with an embodiment, having multiple bitrate variants in an IP-based steaming content format 322, 332, for example, can help manage bandwidth rather effectively while performing, for example, a preview play content 350 as disclosed herein. In addition, the “preview play” content 350 from the digital video recorder (DVR) 310 has relatively no network cost involved since the preview play content 350 is sourced locally, for example, within the set-top box 310. In accordance with an embodiment, for example, while the current selected content 340 is being decoded by the set-top box 120 and displayed on the media play device 130, the “preview play” content 350 can also be decoded by the set-top box 120 and displayed at the same time.

In accordance with an exemplary embodiment, the method to preview content while playing selected content can, for example, use HTTP Live streaming (HLS), which prioritizes audio from current selected content 340 and without audio for the “preview play” content 350. With the flexibility of having different bitrate variants in HLS, the method can choose a desired resolution for the screen real estate on the media play device 130 planned for the “preview play” content 350, which can result in rather effective use of network bandwidth while still preserving viewing quality of both the current selected content 340 and the “preview play” content 350. In addition, when a “preview play” content 350 is instigated from a DVR 310 with or without an IP-based streaming format protocol 322 for the current selected content 340, little or no network effect or taxation will be experienced.

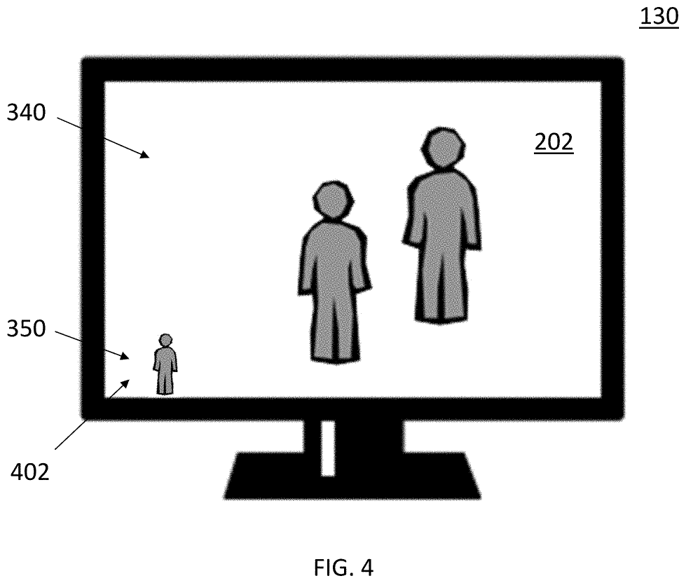

FIG. 4 illustrates a media play device 130 with “preview play” content 340 while playing selected content 350 in accordance with an embodiment. As shown in FIG. 4, the set-top box 120 upon request from a user 124, for example, via an input device 122, can deliver the “preview play” content 350, which can be displayed on the display interface 202 of the media play device 130. In accordance with an embodiment, the “preview play” content 350 can be displayed in a portion (for example, a smaller window or with guide overly graphics) 402 of the display interface 202, for example, in a corner of the display interface 202 so as not to generally interfere with the current selected content 340.

Method for Previewing Content while Playing Selected Content

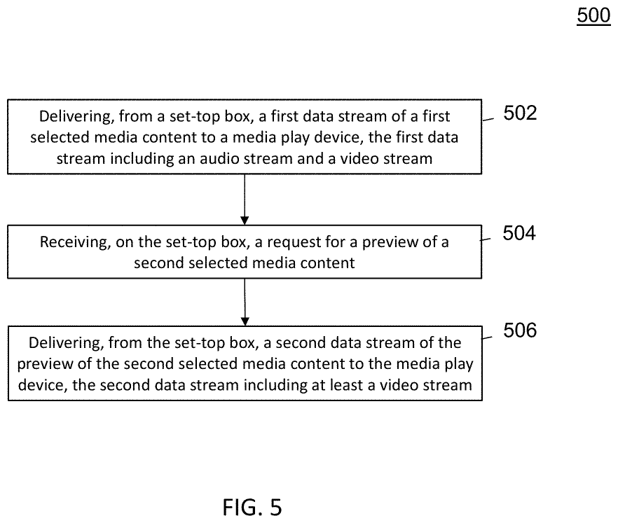

FIG. 5 is a flow chart 500 of a method for previewing content while playing selected content in accordance with an embodiment. As shown in FIG. 5, in step 502, a first data stream of a first selected media content is delivered to a media play device 130 from a set-top box 120. The first data stream including an audio stream and a video stream. In step 504, a request for a preview of a second selected media content is received on the set-top box 120. In step 506, a second data stream of the preview of the second selected media content is delivered to the media play device 130 from the set-top box 120. The second data stream including at least a video stream.

In accordance with an aspect, the first data stream is received on the set-top box 120 in a quadrature amplitude modulation (QAM) format from a broadband server, as a first Internet Protocol-based (IP-based) content stream, or in a first digital video recorder (DVR) format from a digital video recorder. In addition, the second data stream can be received on the set-top box as a second Internet Protocol-based (IP-based) content stream or in the first digital video recorder (DVR) format or a second digital video recorder (DVR) format from the digital video recorder. The first IP-based content stream and/or the second IP-based content stream can be, for example, HTTP Live Streaming (HLS) or Dynamic Adaptive Streaming over HTTP (DASH).

In accordance with another aspect, the first data stream and the second data stream is managed by the set-top box using bitrate variants in the first IP-based content stream and/or the second IP-based content stream. In accordance with an aspect, the second data stream of the preview of the second selected media content can be delivered by the set-top box to the media play device without an audio stream.

In accordance with another aspect, a resolution for the second data stream can be selected by the set-top box based on a size of a window for displaying the preview of the second selected media content on the media play device. The second data stream of the preview of the second selected media content can be, for example, a trailer, a small clip of content, a short scene or a hot spot of a scene, a curated content, thumbnails and/or captured content of movies and/or pre-recorded content, and/or live content. In accordance with an embodiment, after viewing the preview of the second selected media content, for example, the user 124 can select the second selected media content for viewing with the input device 122 in accordance with a voice command and/or input via one or more keys on the input device 122.

Techniques consistent with the present disclosure provide, among other features, systems and methods for previewing content while playing selected content. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for previewing content while playing selected content, the method comprising:
delivering, from a set-top box, a first data stream of a first selected media content to a media play device, the first data stream including an audio stream and a video stream;
receiving, on the set-top box, a request for a preview of a second selected media content; and
delivering, from the set-top box, a second data stream of the preview of the second selected media content to the media play device, the second data stream including at least a video stream.

2. The method according to claim 1, comprising;
receiving, on the set-top box, the first data stream in a quadrature amplitude modulation (QAM) format from a broadband server, as a first Internet Protocol-based (IP-based) content stream, or in a first digital video recorder (DVR) format from a digital video recorder; and
receiving, on the set-top box, the second data stream as a second Internet Protocol-based (IP-based) content stream or in the first digital video recorder (DVR) format or a second digital video recorder (DVR) format from the digital video recorder.

3. The method according to claim 2, wherein the first IP-based content stream and/or the second IP-based content stream is HTTP Live Streaming (HLS) or Dynamic Adaptive Streaming over HTTP (DASH).

4. The method according to claim 3, further comprising:
managing, by the set-top box, the first data stream and the second data stream using bitrate variants in the first IP-based content stream and/or the second IP-based content stream.

5. The method according to claim 1, comprising:
delivering, from the set-top box, the second data stream of the preview of the second selected media content to the media play device without an audio stream.

6. The method according to claim 1, further comprising:
selecting, by the set-top box, a resolution for the second data stream based on a size of a window for displaying the preview of the second selected media content on the media play device.

7. The method according to claim 1, wherein the second data stream of the preview of the second selected media content is a trailer, a small clip of content, a short scene or a hot spot of a scene, a curated content, thumbnails and/or captured content of movies and/or pre-recorded content, and/or live content.

8. A customer-premises equipment device comprising:
a processor configured to:
deliver a first data stream of a first selected media content to a media play device, the first data stream including an audio stream and a video stream;
receive a request for a preview of a second selected media content; and
deliver a second data stream of the preview of the second selected media content to the media play device, the second data stream including at least a video stream.

9. The customer-premises equipment device according to claim 8, further comprising:
a communications interface configured to receive content in a quadrature amplitude modulation (QAM) format from a broadband server or as an Internet Protocol-based (IP-based) content stream.

10. The customer-premises equipment device according to claim 8, wherein the customer-premises equipment device is set-top box, and wherein the processor is configured to:
receiving the first data stream in a quadrature amplitude modulation (QAM) format from a broadband server, as a first Internet Protocol-based (IP-based) content stream, or in a first digital video recorder (DVR) format from a digital video recorder; and
receive the second data stream as a second Internet Protocol-based (IP-based) content stream or in the first digital video recorder (DVR) format or a second digital video recorder (DVR) format from the digital video recorder.

11. The customer-premises equipment device according to claim 10, wherein the first IP-based content stream and/or the second IP-based content stream is HTTP Live Streaming (HLS) or Dynamic Adaptive Streaming over HTTP (DASH).

12. The customer-premises equipment device according to claim 11, wherein the processor is further configured to:
manage the first data stream and the second data stream using bitrate variants in the first IP-based content stream and/or the second IP-based content stream.

13. The customer-premises equipment device according to claim 8, wherein the processor is configured to:
deliver the second data stream of the preview of the second selected media content to the media play device without an audio stream.

14. The customer-premises equipment device according to claim 8, wherein the processor is configured to:
select a resolution for the second data stream based on a size of a window for displaying the preview of the second selected media content on the media play device.

15. The customer-premises equipment device according to claim 8, wherein the second data stream of the preview of the second selected media content is a trailer, a small clip of content, a short scene or a hot spot of a scene, a curated content, thumbnails and/or captured content of movies and/or pre-recorded content, and/or live content.

16. A non-transitory computer readable medium having instructions operable to cause one or more processors to perform operations comprising:
delivering, from a set-top box, a first data stream of a first selected media content to a media play device, the first data stream including an audio stream and a video stream;
receiving, on the set-top box, a request for a preview of a second selected media content; and
delivering, from the set-top box, a second data stream of the preview of the second selected media content to the media play device, the second data stream including at least a video stream.

17. The non-transitory computer readable medium according to claim 16 comprising;
receiving, on the set-top box, the first data stream in a quadrature amplitude modulation (QAM) format from a broadband server, as a first Internet Protocol-based (IP-based) content stream, or in a first digital video recorder (DVR) format from a digital video recorder; and
receiving, on the set-top box, the second data stream as a second Internet Protocol-based (IP-based) content stream or in the first digital video recorder (DVR) format or a second digital video recorder (DVR) format from the digital video recorder.

18. The non-transitory computer readable medium according to claim 17, wherein the first IP-based content stream and/or the second IP-based content stream is HTTP Live Streaming (HLS) or Dynamic Adaptive Streaming over HTTP (DASH).

19. The non-transitory computer readable medium according to claim 18, further comprising:
managing, by the set-top box, the first data stream and the second data stream using bitrate variants in the first IP-based content stream and/or the second IP-based content stream.

20. The non-transitory computer readable medium according to claim 16, comprising:
delivering, from the set-top box, the second data stream of the preview of the second selected media content to the media play device without an audio stream; and
selecting, by the set-top box, a resolution for the second data stream based on a size of a window for displaying the preview of the second selected media content on the media play device.
